(19) United States
(12) Patent Application Publication
(10) Pub. No.: US 2019/0220551 A1
(43) Pub. Date: Jul. 18, 2019

(54) AUTOMATED DESIGN OF A PIPING SYSTEM

(71) Applicant: Siemens Product Lifecycle Management Software Inc., Plano, TX (US)

(72) Inventors: Jerry John Braganza, Pune, Maharashtra (IN); Chinmay Kanitkar, Pune, Maharashtra (IN); Avinash Mauje, Pune, Maharashtra (IN); Nitin Patil, Pune, Maharashtra (IN); Vijay Veer, Aurangabad, Maharashtra (DE)

(21) Appl. No.: 16/331,035

(22) PCT Filed: Dec. 7, 2016
(86) PCT No.: PCT/US2016/065242

§ 371 Date: Mar. 6, 2019

(30) Foreign Application Priority Data
Sep. 20, 2016 (IN) 201631032067

(51) Int. Cl. G06F 17/50

(52) U.S. Cl. CPC G06F 17/50; G06F 2217/34

(57) ABSTRACT

A data processing system for automated design of a piping system and method thereof are disclosed. In one embodiment, a method for automated design of a piping system includes obtaining logical definition data of the piping system with pipe runs from a computer-aided design (CAD) database, and computing a piping path for said each pipe run based on the logical definition data of the piping system. The method includes determining positions of the piping components required for said each pipe run according to the logical definition data based on the computed piping path, and associating the piping components for said each pipe run with the determined positions of the piping components. Moreover, the method includes automatically generating a graphical model of the piping system with the pipe runs based on the association of the piping components with the determined positions for said each pipe run.

### FIELD OF THE INVENTION

The present disclosure relates to the field of computer-aided design (CAD), and more particularly relates to automated design of a piping system.

### BACKGROUND

CAD systems are used for designing, visualizing, and manufacturing simple and complex systems. CAD systems allow designers to design three-dimensional graphic models of systems such as piping systems before or instead of manufacturing physical items. Currently known CAD systems enable designing of three-dimensional graphical models of piping systems in an interactive manner which requires designers to provide a lot of inputs, such as to input appropriate piping components from a list of piping components and specify locations of the piping components along a piping path based on a piping and instrumentation diagram (P&ID) sheet. Due to this, designing of three-dimensional graphical models of entire piping systems using the known CAD systems may be error prone, tedious, and involve a time consuming process.

### SUMMARY

A data processing system for automated design of a piping system and method thereof is disclosed. In one aspect, a method of automated design of a piping system includes obtaining logical definition data of the piping system with one or more pipe runs from a computer-aided design (CAD) database, and computing a piping path for each pipe run based on the logical definition data of the piping system. The method includes determining positions of the one or more piping components for said each pipe run based on the computed piping path for said each pipe run, and associating the one or more piping components for said each pipe run with the determined positions of the piping components. Moreover, the method includes automatically generating a graphical model of the piping system based on the association of the one or more piping components with the determined positions for said each pipe run.

In another aspect, a data processing system includes a processor, and a memory coupled to the processor. The memory includes a CAD module stored in the form of machine-readable instructions and executable by the processor. The CAD module is configured to obtain logical definition data of a piping system with one or more pipe runs, and compute a piping path for each pipe run based on the logical definition data of the piping system. The CAD module is configured to determine positions of the one or more piping components for said each pipe run based on the computed piping path for said each pipe run, and associate the one or more piping components for said each pipe run with the determined positions of the one or more piping components. Moreover, the CAD module is configured to automatically generate a graphical model of the piping system based on the association of the one or more piping components with the determined positions for said each pipe run.

In yet another aspect, a non-transitory computer-readable storage medium, having machine-readable instructions stored therein, which when executed by a data processing system, causes the data processing system to perform method steps described above.

This summary is provided to introduce a selection of concepts in a simplified form that are further described below in the following description. It is not intended to identify features or essential features of the claimed subject matter. Furthermore, the claimed subject matter is not limited to implementations that solve any or all disadvantages noted in any part of this disclosure.

### BRIEF DESCRIPTION OF THE VIEWS OF THE DRAWINGS

A more complete appreciation of the present disclosure and many of the attendant aspects thereof will be readily obtained as the same becomes better understood by reference to the following description when considered in connection with the accompanying drawings:

FIG. 1 illustrates a block diagram of a data processing system in which an embodiment can be implemented;

FIG. 2 illustrates a block diagram of various modules of a computer-aided design (CAD) module of the data processing system;

FIG. 3 is a process flowchart illustrating an exemplary method of automatically designing a piping system, according to an embodiment;

FIG. 4 is a process flowchart illustrating a detailed method of automatically designing the piping system, according to one embodiment;

FIG. 5 is a process flowchart illustrating a detailed method of automatically designing the piping system, according to another embodiment;

FIG. 6 illustrates a block diagram of another data processing system in which an embodiment can be implemented;

FIG. 7 is a schematic representation of logical definition data of a piping system; and

FIG. 8 is a screenshot view depicting an automatically designed graphical model of a piping system.

### DETAILED DESCRIPTION

A data processing system for automated design of a piping system and method thereof are disclosed. Various embodiments are described with reference to the drawings, wherein like reference numerals are used to refer to like elements throughout. In the following description, numerous specific details are set forth in order to provide thorough understanding of embodiments of the present disclosure. It will be apparent to one skilled in the art, that these specific details need not be employed to practice embodiments of the present disclosure. In other instances, well known materials or methods have not been described in detail in order to avoid unnecessarily obscuring embodiments of the present disclosure. While the disclosure is susceptible to various modifications and alternative forms, specific embodiments thereof are shown by way of example in the drawings and will herein be described in detail. It should be understood, however, that there is no intent to limit the disclosure to the particular forms disclosed, but on the contrary, the disclosure is to cover all modifications, equivalents, and alternatives falling within the spirit and scope of the present disclosure.

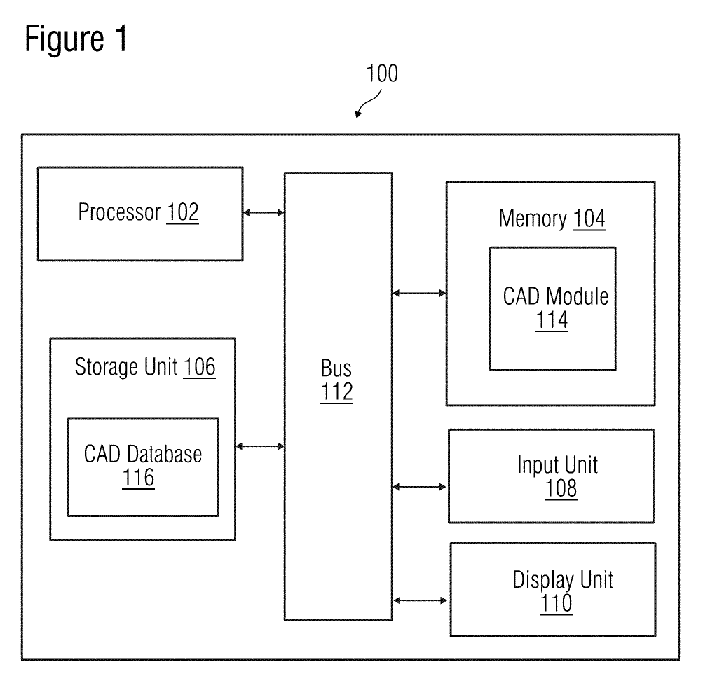

FIG. 1 illustrates a block diagram of a data processing system 100 in which an embodiment can be implemented, for example, as a computer-aided design (CAD) system, particularly configured by software or otherwise to perform the processes as described herein. The data processing system 100 may be a personal computer, a laptop computer, a tablet, and the like. In FIG. 1, the data processing system 100 includes a processor 102, an accessible memory 104, a storage unit 106, an input unit 108, a display unit 110, and a bus 112.

The processor 102, as used herein, means any type of computational circuit, such as, but not limited to, a microprocessor, microcontroller, complex instruction set computing microprocessor, reduced instruction set computing microprocessor, very long instruction word microprocessor, explicitly parallel instruction computing microprocessor, graphics processor, digital signal processor, or any other type of processing circuit. The processor 102 may also include embedded controllers, such as generic or programmable logic devices or arrays, application specific integrated circuits, single-chip computers, and the like.

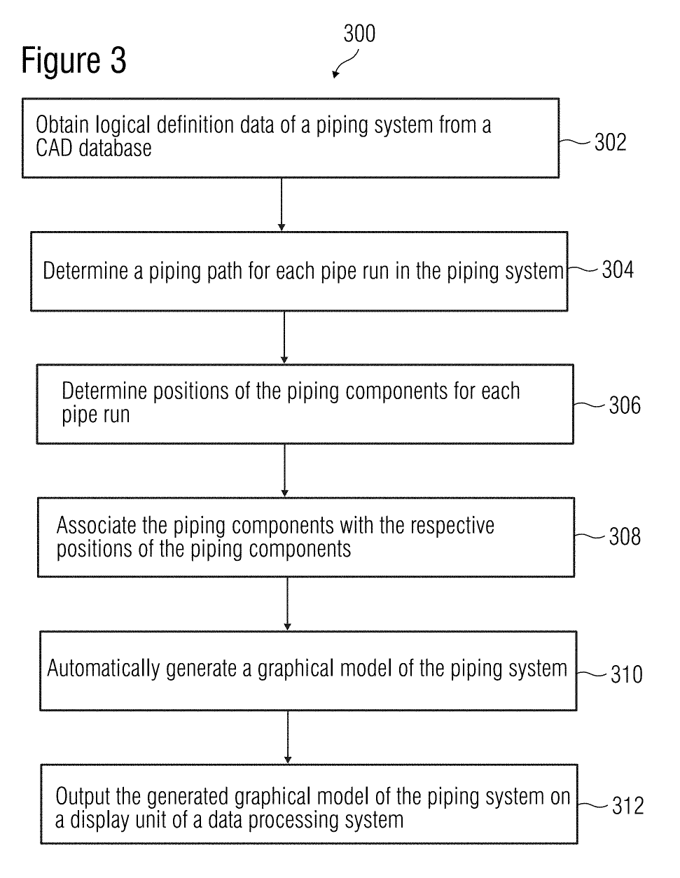

The memory 104 may be non-transitory volatile memory and non-volatile memory. The memory 104 may be coupled for communication with the processor 102, such as being a computer-readable storage medium. The processor 102 may execute instructions and/or code stored in the memory 104. A variety of computer-readable instructions may be stored in and accessed from the memory 104. The memory 104 may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 104 includes a CAD module 114 stored in the form of machine-readable instructions on any of the above-mentioned storage media and may be in communication to and executed by the processor 102. When executed by the processor 102, the CAD module 114 causes the processor 102 to automatically design a graphical model of a piping system based on logical definition data of the piping system. Method steps performed by the processor 102 to achieve the above functionality are described in greater detail in FIGS. 3, 4 and 5.

The storage unit 106 may be a non-transitory storage medium which stores a CAD database 116. The CAD database 116 stores logical definition data associated with a plurality of piping systems. The CAD database 116 also stores graphical models of the piping systems designed based on the logical definition data. The input unit 108 may include input devices such as keypad, touch-sensitive display, camera (such as a camera receiving gesture-based inputs), etc. capable of receiving input signals such as a file including logical definition data of the piping system. The display unit 110 may be a device for displaying a CAD interface which visualizes the graphical model of the piping system. The bus 112 acts as interconnect between the processor 102, the memory 104, the storage unit 106, the input unit 108, and the output unit 110.

Those of ordinary skilled in the art will appreciate that the hardware depicted in FIG. 1 may vary for particular implementations. For example, other peripheral devices such as an optical disk drive and the like, Local Area Network (LAN)/Wide Area Network (WAN)/Wireless (e.g., Wi-Fi) adapter, graphics adapter, disk controller, input/output (I/O) adapter also may be used in addition to or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously with each display window providing an interface to a different application or to a different instance of the same application. A cursor in the graphical user interface may be manipulated by a user through the pointing device. The position of the cursor may be changed and/or an event such as clicking a mouse button, generated to actuate a desired response.

One of various commercial operating systems, such as a version of Microsoft Windows™ a product of Microsoft Corporation located in Redmond, Wash. may be employed if suitably modified. The operating system is modified or created in accordance with the present disclosure as described.

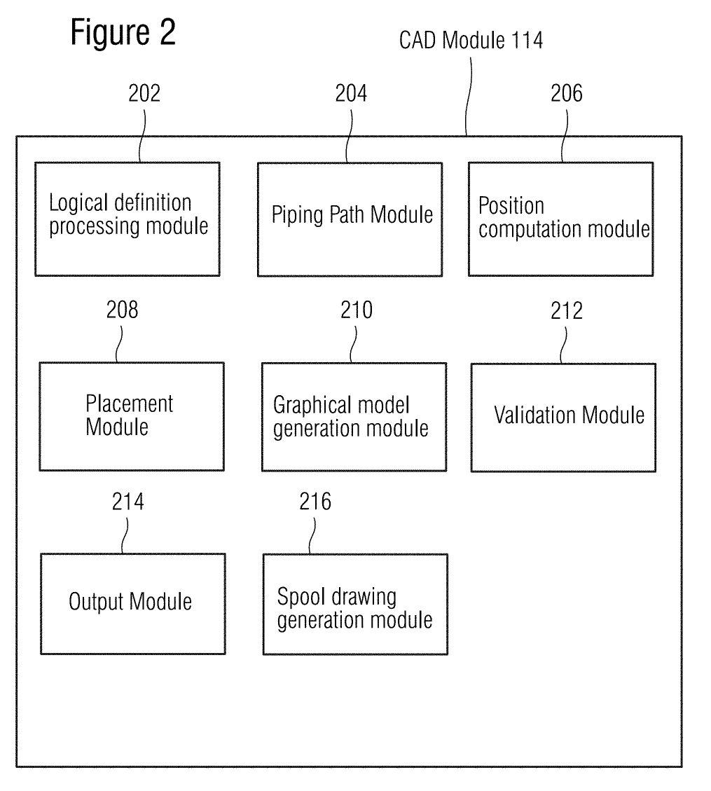

FIG. 2 illustrates a block diagram of various modules of the CAD module 114 of FIG. 1. The CAD module 114 includes a logical definition processing module 202, a piping path module 204, a position computation module 206, a placement module 208, a graphical model generation module 210, a validation module 212, an output module 214, and a spool drawing generation module 216.

The logical definition processing module 202 is configured to obtain and interpret logical definition data of a piping system from the CAD database 116. The piping system includes one or more pipe runs. Each of the pipe runs contains piping components such as pipes, valves, etc. and connects a source equipment (e.g., a pump) and target equipment (e.g., tank). The logical definition data of the piping system includes piping components information and information associated with connections between different piping components in each pipe run of the piping system. The piping component information may indicate equipment to which pipes are to be connected, pipe specification, bend radius, insulation information, valves, and other instrumentation with sequence information. The information associated with connections indicates connection points at equipment between which pipes are to be connected.

In some embodiments, the logical definition processing module 202 is configured to determine a graphical state of the piping system by comparing with the logical definition data if a graphical model of the piping system exists. That is, the logical definition processing module 202 determines whether the graphical model of the piping system is partially complete so that the graphical model can be automatically completed. This eliminates a need to redesign the entire piping system when the partially complete graphical model of the piping system is available.

The piping path module 204 is configured to compute piping path for each pipe run in the piping system based on the logical definition data of the piping system. For example, the piping path module 204 creates a series of segments connecting first equipment and second equipment. The position computation module 206 is configured to determine pipe size and bend/elbow for each pipe run based on the logical definition data of the piping system. Furthermore, the position computation module 206 is configured to determine positions of piping components required for designing said each pipe run along the series of segments in the computed piping path. In an embodiment, the position computation module 206 is configured to compare the desired dimension of a piping component (e.g., width of a valve) along an axis of the selected pipe run with length of a first available segment in the computed piping path. The position computation module 206 is configured to determine whether the length of the first segment is greater than the desired dimension of the piping component. The amount by which the length of the first segment shall be greater than the desired dimension of the piping component is pre-defined. Then, the position computation module 206 computes a point on the first segment at a length equal to the desired dimension of the piping component. The computed point indicates the probable position of the piping component in the pipe run. It can be noted that the positions of the piping components are determined with respect to geometric coordinates within a three-dimensional space along the computed piping path.

The placement module 208 is configured to associate the piping components associated with said each pipe run with the determined positions of the piping components in a particular sequence defined in the logical definition data. For example, each piping component is associated with the computed point on the respective segment such that the center point of the piping component coincides with the computed point on the respective segment. For instance, a pipe of a particular size is automatically linked to a set of geometric coordinates associated with the computed point in the three-dimensional space. The placement module 208 is also configured to add piping accessories to the piping components for said each pipe run. For example, if a flanged valve is used, appropriate flanges are linked to the flanged value along the pipe run. The placement module 208 is configured to add insulation, heat treatment specifications, color, nozzles, flanges, and other instrumentation to the pipe run as indicated in the logical definition data.

The graphical model generation module 210 is configured to generate a graphical model of the piping system. In one embodiment, the graphical model of the piping system is a three-dimensional CAD model of the piping system. The validation module 212 is configured to validate the graphical model of the piping system with respect to the logical definition data. For example, the validation module 212 is configured to determine whether the graphical model is consistent with the logical definition data and refine the graphical model based on validation errors. The output module 214 is configured to visualize the graphical model of the piping system on the display unit 110. The spool drawing generation module 216 is configured to generate a piping isometric spool drawing based on the graphical model of the piping system.

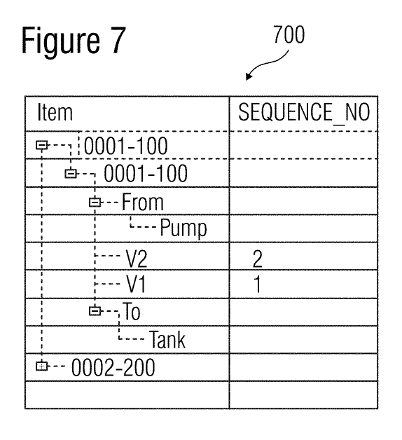

FIG. 3 is a process flowchart 300 illustrating an exemplary method of automatically designing a piping system, according to an embodiment. At step 302, logical definition data of a piping system is obtained from the CAD database 116. The logical definition data of the piping system includes piping components' information and information associated with connections between different piping components in each pipe run of the piping system. The piping component information may indicate equipment to which pipes are to be connected, pipe specification, bend radius, insulation information, valves, and other instrumentation with sequence information. The information associated with connections indicates connection points at equipment between which pipes are to be connected. An exemplary logical definition data structure 700 is depicted in FIG. 7. At step 304, a piping path for each pipe run in the piping system is determined. In an embodiment, a first connection point at a source equipment and a second connection point at a target equipment associated with a pipe run are automatically identified using the logical definition data. Then, a plurality of piping paths from the source equipment to the target equipment is computed. An optimal piping path is selected from the plurality of piping paths based on pre-defined criteria. For example, the pre-defined criteria may include a minimum number of bend corners, non-interference with equipment or piping components of the piping system, etc. The optimal piping path contains a series of segments between the first connection point and the second connection point in a sequential order. The optimal piping path can be computed using any of known algorithms.

At step 306, positions of piping components for said each pipe run are determined based on the computed piping path. In one exemplary implementation, a piping component from the piping components for the pipe run is selected. A segment in the series of segments in which placement of the piping component is required is determined. For example, each segment is traced in the sequential order to determine whether there is a need to position the selected piping component in any of the segments. Initially, a first segment associated with the first connection point is selected. For example, the first segment is a segment which has a length longer than a length required for positioning the piping component. The length required for positioning the piping component may include additional pipe length on either side of the piping component. If the piping component has multiple ports, then the distance between opposing ports is considered as the length of the piping component.

Then, it is determined whether there exists a possibility for positioning the selected piping components in the first segment. If there is no possibility to position the piping component in the first segment, a next segment in the sequential order is selected and a possibility to position the piping component is determined. In this manner, each of the segments is traced in the sequential order. If there exists a possibility to position the piping components in the first segment, then position of the piping component in the first segment is computed. The position of the piping component along the first segment is computed with respect to geometric coordinates in a three-dimensional space along the computed piping path. Thereafter, a next piping component in the list of piping components is selected, and the above steps are repeated. In this manner, positions of the piping components of the pipe run are determined along the computed piping path.

At step 308, the piping components for said each pipe run are associated with the determined positions of the piping components. For example, the piping components required for designing the piping system are selected from a list of piping components based on the logical definition data. Each of the piping components of particular specification (e.g., number, size, material, etc.) is linked with the corresponding position determined in step 306.

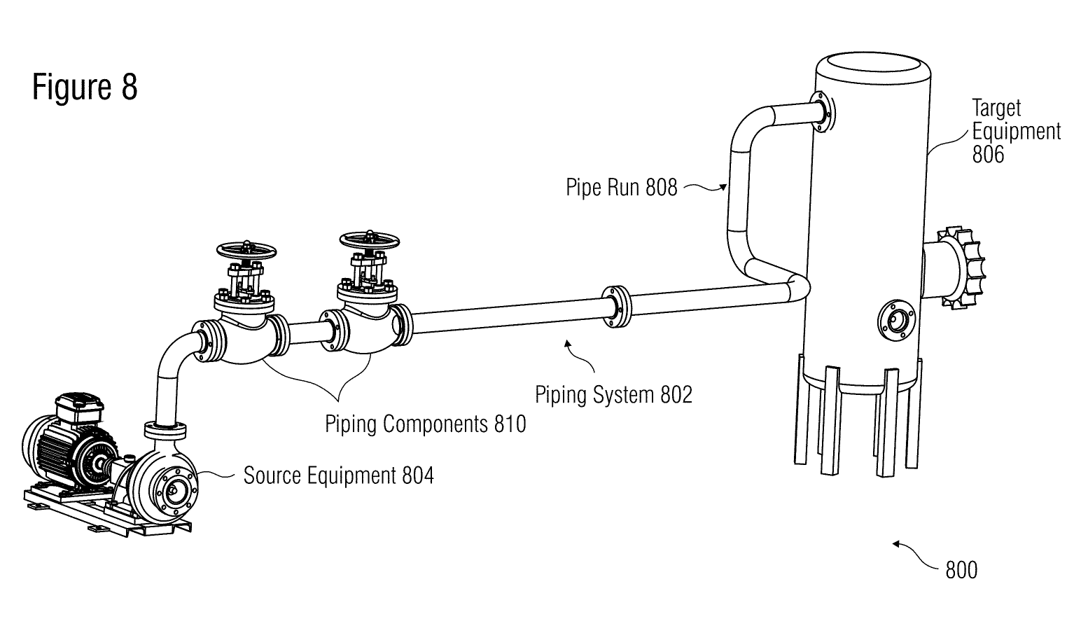

At step 310, a graphical model of the piping system is automatically generated based on the association of the piping components with the positions of the piping components. At step 312, the generated graphical model of the piping system is output on the display unit 110. The generated graphical model of the piping system is visualized as a three-dimensional model on the display unit 110. A three dimensional model of piping system 802 automatically generated by the data processing system 100 using logical definition data is depicted in FIG. 8. The three dimensional model of piping system 802 contains a source equipment 804, a target equipment 806, and a pipe run 808 with piping components 810 connecting the source equipment 804 and the target equipment 806.

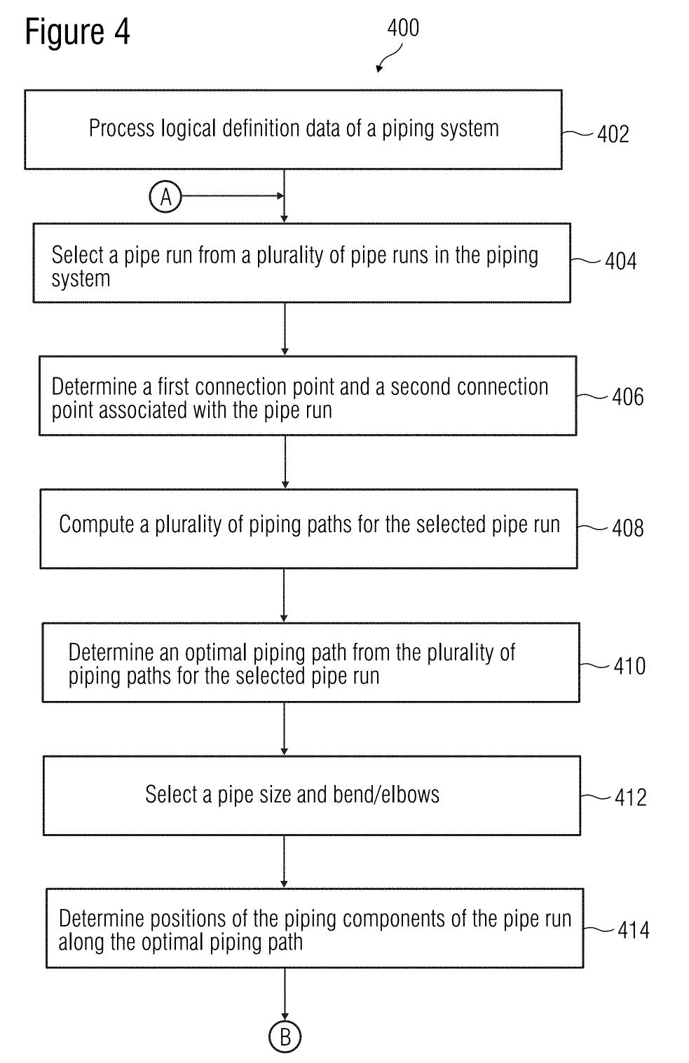

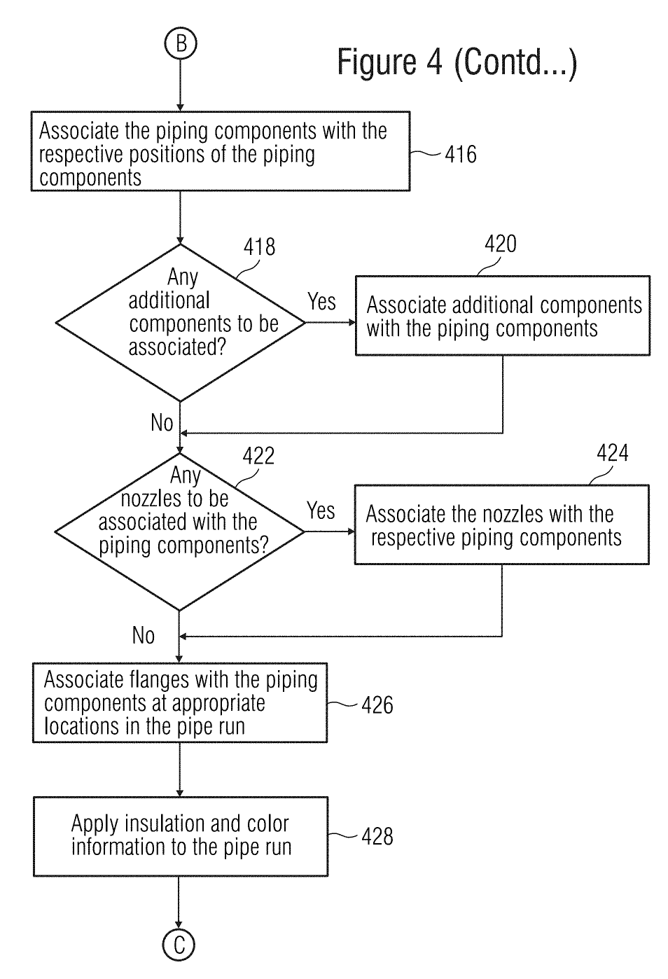

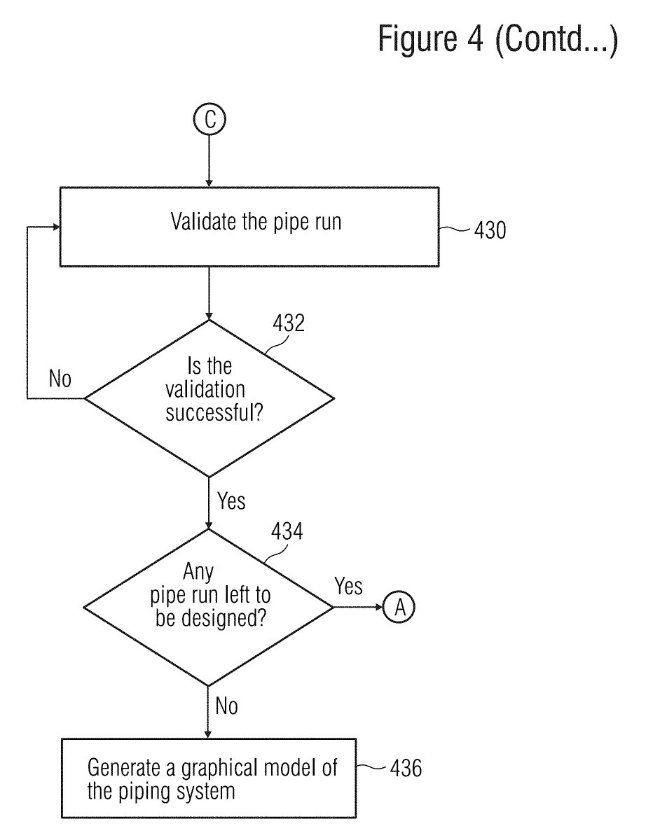

FIG. 4 is a process flowchart 400 illustrating a detailed method of automatically designing a piping system, according to one embodiment. At step 402, logical definition data of a piping system to be designed is processed. For example, the logical definition data of the piping system is obtained from the CAD database 116, and piping component information and information associated with connections between different piping components in said each piping run of the piping system is extracted from the logical definition data. At step 404, a pipe run is selected from a plurality of pipe runs in the piping system. At step 406, a first connection point and a second connection point associated with the selected pipe run is determined. For example, the first connection point corresponds to a source equipment and the second connection point corresponds to a target equipment, where the pipe run connects the source equipment and the target equipment. In one embodiment, the information associated with connections between different piping components indicates the first connection point and the second connection point associated with the pipe run. In this embodiment, the first connection point and the second connection are determined using the connections information in the logical definition data.

At step 408, a plurality of piping paths for the selected pipe run is computed. For example, the piping paths are created from the first connection point to the second connection point. Each piping path includes a series of linear segment. At step 410, an optimal piping path is determined from the plurality of piping paths based on predefined criteria. It can be noted that the optimal path is determined using routing algorithms well known in the art.

At step 412, pipe size and bends/elbows associated with the pipe run are selected using the piping component information. In one embodiment, the piping component information indicates pipe size information and bend radius definition corresponding to the pipe size information. In this embodiment, the pipe size and bends/elbows are selected based on the pipe size information and corresponding bend radius definition.

At step 414, positions of piping components are determined based on the optimal piping path. For example, the positions of the piping components are determined with respect to geometric coordinates in three dimensional space. At step 416, each of the piping components is associated with the determined positions of the piping components. For example, each of the piping components are mapped to the geometric coordinates in the three dimensional space.

At step 418, it is determined whether additional piping components are to be associated with any of the piping components. If additional piping components are to be associated, then at step 420, the additional piping components are associated with respective piping components and the step 422 is performed. For example, flanges are associated with flange valves present in the pipe run. If no additional piping components are to be associated, then at step 422, it is determined whether any nozzles are to be associated with the piping components. If nozzles are to be associated with the piping components, then at step 424, nozzles are associated with the respective piping components. If no nozzles are to be associated, then at step 426, flanges are associated at the appropriate locations in the pipe run. At step 428, insulation and color information is applied to the piping components. At step 430, the pipe run is validated.

At step 432, it is determined whether the pipe run is validated successfully. If the pipe run is validated successfully, then at step 434, it is determined whether any pipe run is remaining in the plurality of pipe runs. If all pipe runs are designed, then at step 436, a graphical model of the piping system is generated. If one or more pipe runs are remaining, then step 404 is repeated.

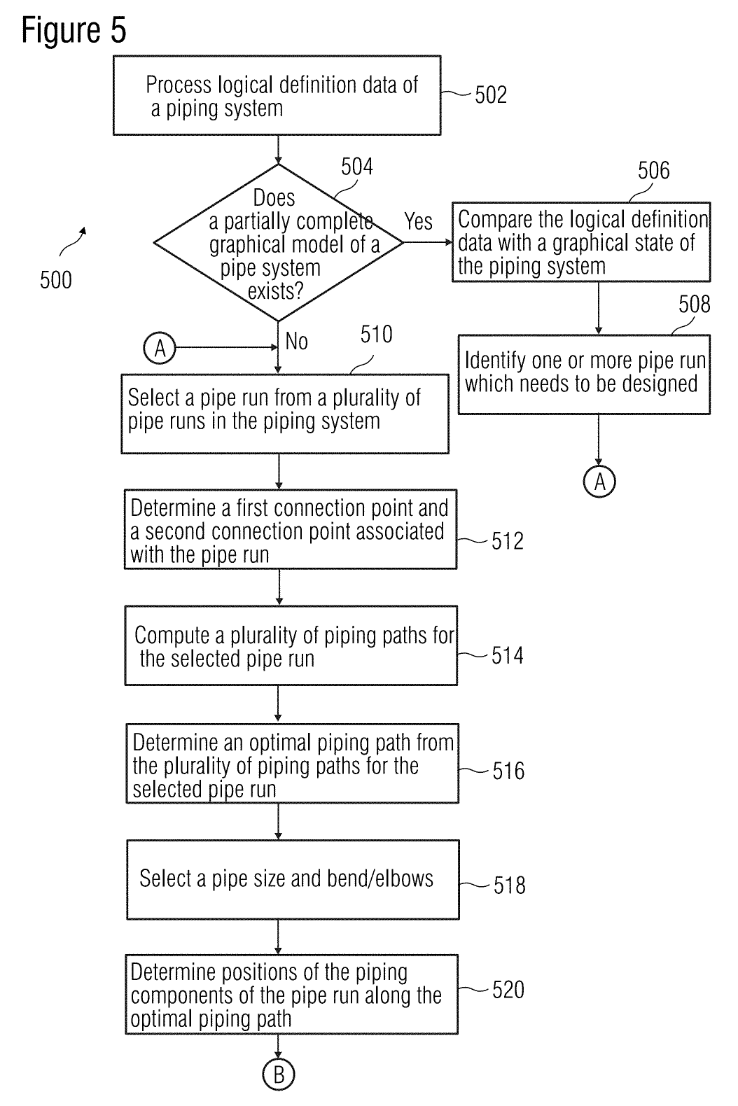

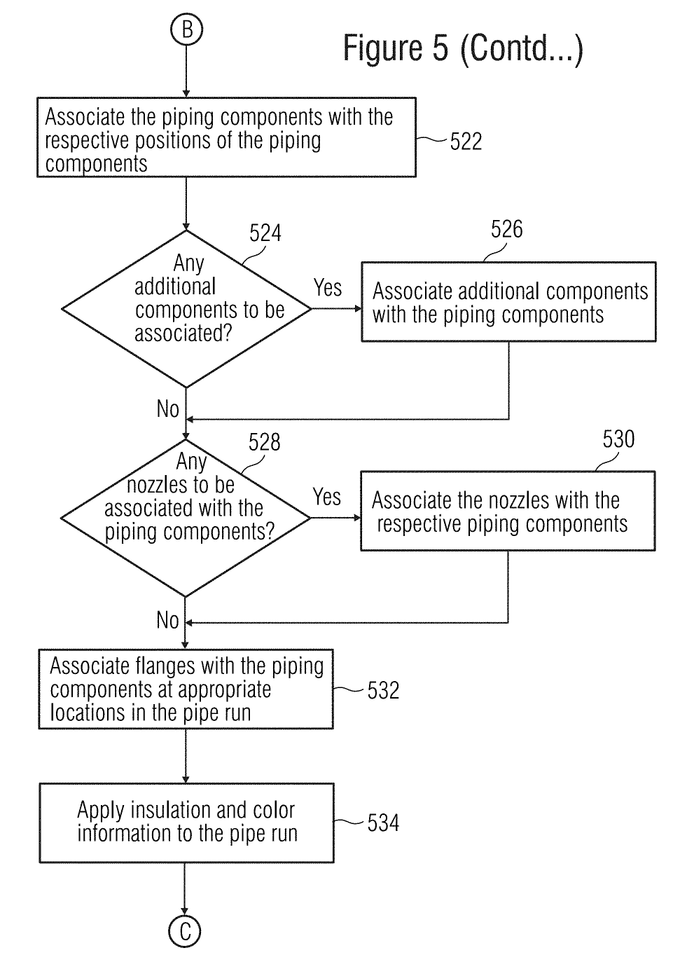

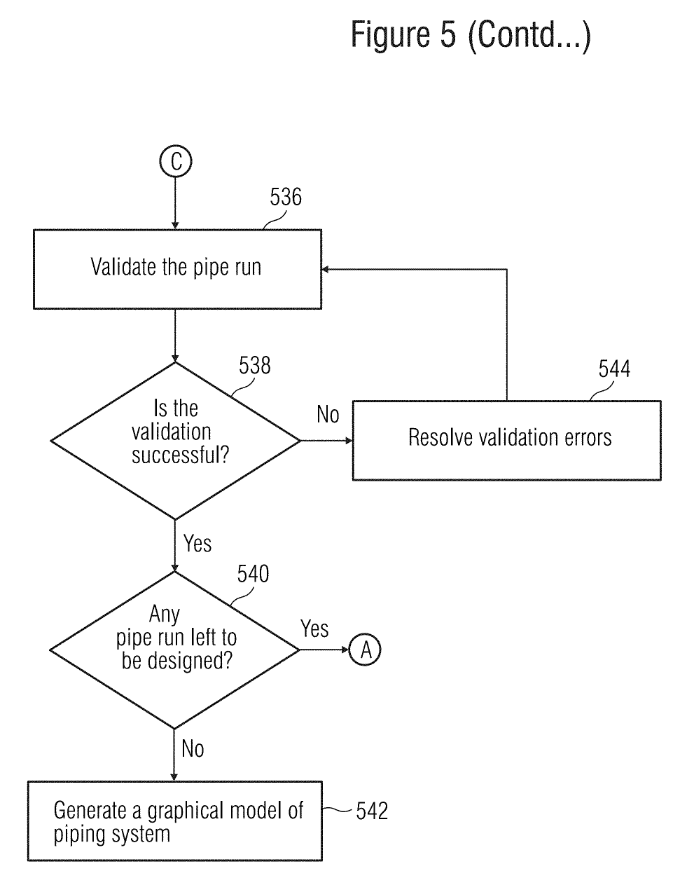

FIG. 5 is a process flowchart 500 illustrating a detailed method of automatically designing a piping system, according to another embodiment. At step 502, logical definition data of a piping system to be designed is processed. At step 504, it is determined whether a partially complete graphical model of the piping system is available. For example, the CAD database is searched for the partially complete graphical model of the piping system. Alternatively, a piping engineer may input the partially complete graphical model of the piping system. If the partially complete graphical model does not exist, then step 510 is performed. If the partially complete graphical model exists, then at step 506, the logical definition data is compared with the graphical model of the piping system. Thus, the graphical state of the graphical model is determined based on the outcome of comparison. At step 508, one or more pipe runs which need to be designed to complete the graphical model are identified based on the graphical state of the graphical model.

At step 510, a pipe run is selected from a plurality of pipe runs in the piping system. At step 512, a first connection point and a second connection point associated with the selected pipe run is determined. At step 514, a plurality of piping paths for the selected pipe run is computed. At step 516, an optimal piping path is determined from the plurality of piping paths based on predefined criteria. At step 518, pipe size and bends/elbows associated with the pipe run are selected using the piping component information.

At step 520, positions of piping components are determined based on the optimal piping path. At step 522, each of the piping components is associated with the respective positions of the piping components. At step 524, it is determined whether additional piping components are to be associated with any of the piping components. If additional piping components are to be associated, then at step 526, the additional piping components are associated with respective piping components and the step 528 is performed. If no additional piping components are to be associated, then at step 528, it is determined whether any nozzles are to be associated with the piping components. If nozzles are to be associated with the piping components, then at step 530, nozzles are associated with the respective piping components. If no nozzles are to be associated, then at step 532, flanges are associated at the appropriate locations in the pipe run. At step 534, insulation and color information is applied to the piping components. At step 536, the pipe run is validated.

At step 538, it is determined whether the pipe run is validated successfully. If the pipe run is not successfully validated, then at step 544, validation errors are resolved and the step 536 is repeated. If the pipe run is validated successfully, then at step 540, it is determined whether any pipe run is remaining in the plurality of pipe runs. If all pipe runs are designed, then at step 542, a complete graphical model of the piping system is generated. If one or more pipe runs are remaining, then step 510 is repeated.

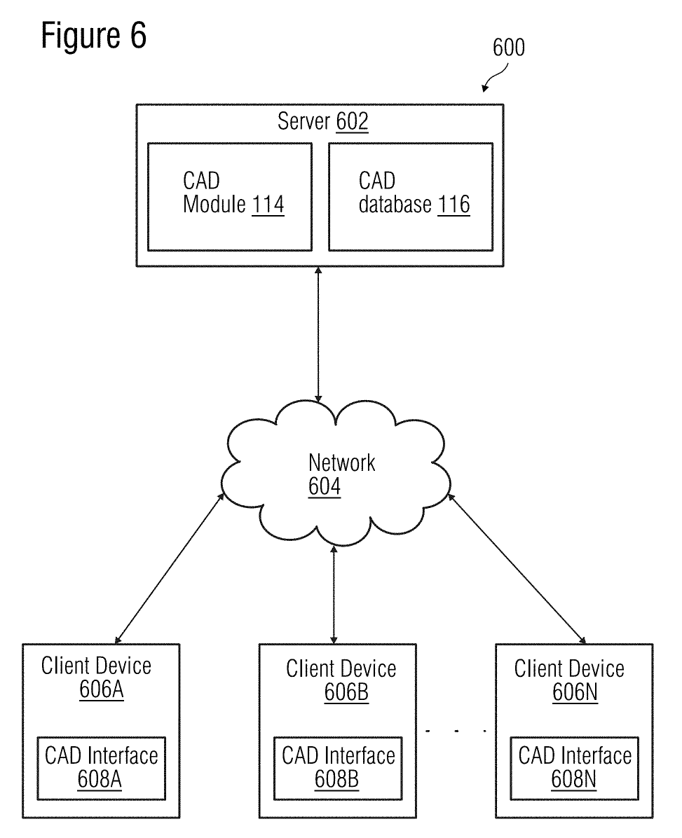

FIG. 6 illustrates a block diagram of a data processing system 600 in which an embodiment can be implemented. Particularly, the data processing system 600 includes a server 602 and a plurality of client devices 606A-N. Each of the client devices 606A-N is connected to the server 602 via a network 604 (e.g., Local Area Network (LAN), Wide Area Network (WAN), Wi-Fi, etc.). The data processing system 600 is another implementation of the data processing system 100 of FIG. 1, wherein the CAD module 114 resides in the server 602 and is accessed by client devices 606A-N via the network 604.

The server 602 includes the CAD module 114 and the CAD database 116. The server 602 may also include a processor, a memory, and a storage unit. The CAD module 114 may be stored on the memory in the form of machine-readable instructions and executable by the processor. The CAD database 116 may be stored in the storage unit. The server 602 may also include a communication interface for enabling communication with client devices 606A-N via the network 604.

When the machine-readable instructions are executed, the CAD module 114 causes the server 602 to compute a piping path for each pipe run in a piping system, determine positions of piping components in said each pipe run, associate each of the piping components with respective positions, and generates a graphical model of the piping system. Method steps performed by the server 602 to achieve the above-mentioned functionality are described in greater detail in FIGS. 3 to 5.

The client devices 606A-N include CAD interfaces 608A-N for visualizing the graphical model of the piping system generated by the server 602. Each of the client devices 606 may be provided with a communication interface for interfacing with the server 602. Users of the client devices 606A-N can access the server 602 via the CAD interfaces 608A-N. For example, the users may send request to the server 602 to generate a graphical model of a piping system from the respective client devices 606A-N. The CAD interfaces 608A-N may be specifically designed for accessing the CAD module 114 in the server 602.

One can envision that, the CAD module 114 may reside in a cloud server in a cloud computing environment, wherein the client devices 606A-N connected via a cloud network may access the CAD module 114 to automatically design a piping system.

Disclosed embodiments provide systems and methods that provide automatically design of a piping system. In particular, the systems and methods may automatically create a three-dimensional graphical model of a piping system based on logical definition data of the piping system. The systems and methods may automatically design specific pipe runs of a piping system and also the complete piping system. The systems and methods may significantly reduce design cycle time and eliminate errors in design. Also, the systems and methods eliminate frequent inputs required from a piping designer while designing a piping system using conventional design techniques, thereby reducing efforts and time required to design the piping system and eliminating errors in designing the piping system.

Of course, those skilled in the art will recognize that, unless specifically indicated or required by the sequence of operations, certain steps in the processes described above may be omitted, performed concurrently or sequentially, or performed in a different order.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of the data processing system may conform to any of the various current implementation and practices known in the art.

It is to be understood that the system and methods described herein may be implemented in various forms of hardware, software, firmware, special purpose processors, or a combination thereof. One or more of the present embodiments may take a form of a computer program product comprising program modules accessible from computer-usable or computer-readable medium storing program code for use by or in connection with one or more computers, processors, or instruction execution system. For the purpose of this description, a computer-usable or computer-readable medium can be any apparatus that can contain, store, communicate, propagate, or transport the program for use by or in connection with the instruction execution system, apparatus, or device. The medium can be electronic, magnetic, optical, electromagnetic, infrared, or semiconductor system (or apparatus or device) or a propagation mediums in and of themselves as signal carriers are not included in the definition of physical computer-readable medium include a semiconductor or solid state memory, magnetic tape, a removable computer diskette, random access memory (RAM), a read only memory (ROM), a rigid magnetic disk and optical disk such as compact disk read-only memory (CD-ROM), compact disk read/write, and digital versatile disc (DVD). Both processors and program code for implementing each aspect of the technology can be centralized or distributed (or a combination thereof) as known to those skilled in the art.

While the present disclosure has been described in detail with reference to certain embodiments, it should be appreciated that the present disclosure is not limited to those embodiments. In view of the present disclosure, many modifications and variations would be present themselves, to those skilled in the art without departing from the scope of the various embodiments of the present disclosure, as described herein. The scope of the present disclosure is, therefore, indicated by the following claims rather than by the foregoing description. All changes, modifications, and variations coming within the meaning and range of equivalency of the claims are to be considered within their scope.

What is claimed is:

1. A computer-implemented method of automatically designing of a piping system, comprising:
obtaining, by a data processing system, logical definition data of a piping system with one or more pipe runs from a computer-aided design (CAD) database;
computing a piping path for each pipe run based on the logical definition data of the piping system;
determining positions of one or more piping components for each pipe run based on the computed piping path for said each pipe run;
associating the one or more piping components for said each pipe run with the determined positions of the one or more piping components; and
automatically generating a graphical model of the piping system based on the association of the one or more piping components with the determined positions for said each pipe run.

2. The method of claim 1, further comprising:
outputting the generated graphical model of the piping system on a display unit of the data processing system.

3. The method of claim 1, further comprising:
selecting a pipe run from the one or more pipe runs.

4. The method of claim 3, wherein computing the piping path for said each pipe run based on the logical definition data of the piping system comprises:
determining a first connection point and a second connection point associated with the selected pipe run;
computing a plurality of piping paths for the selected pipe run based on the first connection point and the second connection point; and
determining an optimal piping path from the plurality of piping paths for the selected pipe run based on pre-defined criteria, wherein the piping path comprises a series of segments in a sequence.

5. The method of claim 4, wherein determining positions of the one or more piping components for said each pipe run based on the computed piping path for said each pipe run comprises:
selecting a piping component from the one or more piping components for the pipe run;
determining a segment in the series of segment which requires positioning of the selected piping component;
computing a position of the selected piping component in the segment; and
repeating the steps of selecting, determining and computing for remaining piping components.

6. The method of claim 1, further comprising:
validating the graphical model of the piping system based on the logical definition data of the piping system.

7. The method of claim 6, further comprising:
determining whether the graphical model of the piping system is successfully validated; and
when validation of the graphical model is unsuccessful, updating the graphical model of the piping system based on the logical definition data of the piping system.

8. The method of claim 1, further comprising:
determining a graphical state of the piping system based on the logical definition data of the piping system; and
determining at least one pipe run in the piping system which needs to be designed based on the graphical state of the piping system.

9. The method of claim 1, wherein the logical definition data comprises piping components information and information associated with connections between the one or more piping components in said each pipe run of the piping system.

10. A data processing system comprising:
a processor;
a memory coupled to the processor, wherein the memory comprises a CAD module configured to:
obtain logical definition data of a piping system with one or more pipe runs;
compute a piping path for each pipe run based on the logical definition data of the piping system;
determine positions of the one or more piping components for each pipe run based on the computed piping path for said each pipe run;
associate the one or more piping components for said each pipe run with the determined positions of the one or more piping components; and
automatically generate a graphical model of the piping system based on the association of the one or more piping components with the determined positions for said each pipe run.

11. The data processing system of claim 10, further comprising a display unit for outputting the generated graphical model of the piping system.

12. The data processing system of claim 10, wherein the CAD module is configured to select a pipe run from the one or more pipe runs.

13. The data processing system of claim 12, wherein in computing the piping path for said each pipe run based on the logical definition data of the piping system, the CAD module is configured to:
determine a first connection point and a second connection point associated with the selected pipe run;
compute a plurality of piping paths for the selected pipe run based on the first connection point and the second connection point; and
determine an optimal piping path from the plurality of piping paths for the selected pipe run based on a pre-defined criteria, wherein the piping path comprises a series of segments in a sequence.

14. The data processing system of claim 13, wherein in determining positions of the one or more piping components for said each pipe run, the CAD module is configured to:
select a piping component from the one or more piping components for the pipe run;
determine a segment in the series of segment which requires positioning of the selected piping component;
compute a position of the selected piping component in the segment; and
repeat the selection, determination and computation for remaining piping components.

15. The data processing system of claim 10, wherein the CAD module is configured to validate the graphical model of the piping system based on the logical definition data of the piping system.

16. The data processing system of claim 15, wherein the CAD module is configured to:
determine whether the graphical model of the piping system is successfully validated; and
update the graphical model of the piping system based on the logical definition data of the piping system if validation of the graphical model is unsuccessful.

17. The data processing system of claim 11, wherein the CAD module is configured to:
determine a graphical state of the piping system based on the logical definition data of the piping system; and
determine at least one pipe run in the piping system which needs to be designed based on the graphical state of the piping system.

18. A non-transitory computer-readable storage medium, having machine-readable instructions stored therein, which when executed by a data processing system, causes the data processing system to perform method steps comprising:
obtain logical definition data of a piping system with one or more pipe runs;
compute a piping path for each pipe run based on the logical definition data of the piping system;
determine positions of the one or more piping components for each pipe run based on the computed piping path for said each pipe run;
associate the one or more piping components for said each pipe run with the determined positions of the one or more piping components; and
automatically generate a graphical model of the piping system based on the association of the one or more piping components with the determined positions for said each pipe run.

19. The storage medium of claim 18, wherein in determining positions of the one or more piping components for said each pipe run, the method steps performed by the data processing system comprises:
selecting a piping component from the one or more piping components for said each pipe run;
determining a segment in a series of segment in the piping path which requires positioning of the selected piping component;
computing a position of the selected piping component in the segment; and
repeating the steps of selecting, determining and computing for remaining piping components.

20. The storage medium of claim 18, wherein the instructions cause the data processing system to perform a method step comprising:
determining a graphical state of the piping system based on the logical definition data of the piping system; and
determining at least one pipe run in the piping system which needs to be designed based on the graphical state of the piping system.
